(19) United States
(12) Patent Application Publication
(10) Pub. No.: US 2022/0076344 A1
(43) Pub. Date: Mar. 10, 2022

(54) Collaborative Data Platform And Methods Of Use

(71) Applicant: Noble Wealth, Inc., Milton, DE (US)

(72) Inventor: Kyle Bailey, Atlanta, GA (US)

(21) Appl. No.: 17/469,808

(22) Filed: Sep. 8, 2021

Related U.S. Application Data
(60) Provisional application No. 63/075,706, filed on Sep. 8, 2020.

(51) Int. Cl. G06Q 40/06; H04L 12/58

(52) U.S. Cl. CPC G06Q 40/06; H04L 51/22

(57) ABSTRACT

The disclosure generally pertains to a collaborative platform that is utilized for various purposes such as for sharing information on a subject of interest with members of a group of people. In an example method of operation, a software application is provided in a first personal communication device, which is a part of the collaborative platform, and is used by a first individual of the group. A processor in the first personal communication device executes the software application and evaluates an email in order to identify, in the email, an item that is a subject of interest to members of the group. If such an item is identified in the email, information about the item is transmitted to a second personal communication device, which may include a substantially identical software application that displays the information to a second individual of the group.

### CROSS-REFERENCE TO RELATED APPLICATION

The present filing claims priority to U.S. Provisional Patent Application, Ser. No. 63/075,706, filed on Sep. 8, 2020, which is hereby incorporated by reference in its entirety.

### BACKGROUND

Professionals employed by institutions such as brokerage firms, investment companies, and banks typically have access to various sophisticated tools that can be used for making investment decisions. For example, a professional stockbroker may have access to information about trades in real time and can quickly execute buy and sell operations based on rapidly changing scenarios. Consequently, a typical investor may entrust the professional stockbroker with carrying out trades that will monetarily benefit the investor. However, the interests of the investor may not align with the interests of the stockbroker. Such conflicts of interest can lead to questions pertaining to trust when a customer deals with an institution such as a brokerage firm. Therefore, it is desirable to provide solutions to the investor that enable real-time access to information without the requirement to use brokerage firms.

### SUMMARY

According to an example aspect of the disclosure, a collaborative platform may be utilized by a group of people to share information on a subject of interest to members of the group and execute actions that may be based on the shared information.

In a first example implementation in accordance with the disclosure, a method involves launching a software application in a first personal communication device that is a part of a collaborative platform. The software application is executed by a first processor in the first personal communication device. Based on executing the software application, an email obtained from a server computer is evaluated to identify, in the email, an item that is a subject of interest to members of a group that use the collaborative platform. Information about the item described in the email is then transmitted to a second personal communication device that includes the software application.

In a second example implementation in accordance with the disclosure, a system includes a server computer and a first personal communication device. The first personal communication device includes an email module, a first software application, and a first communications interface. The email module is configured to obtain an email from the server computer. The first software application is stored in a first memory device and is executable by a first processor for performing at least a first operation of a collaborative platform. The first operation can include evaluating the email obtained from the server computer and identifying, in the email, an item that is a subject of interest to members of a group that use a collaborative platform. The first communications interface is configured to transmit information about the item that is described in the email to at least a second communication device.

In a third example implementation in accordance with the disclosure, a computer-readable storage medium has computer-executable instructions for performing operations that include execution of a software application by a processor in a first personal communication device. The operations further include evaluating, by the processor, based on executing the software application, an email obtained from a server computer and identifying, by the processor, in the email, an item that is a subject of interest to members of a group that use a collaborative platform. The collaborative platform includes the first personal communication device and a second personal communication device. As a further part of the operations, information about the item described in the email is transmitted to a second personal communication device that includes the software application.

Further aspects of the disclosure are shown in the specification, drawings, and claims below.

### BRIEF DESCRIPTION OF THE DRAWINGS

Many aspects of the invention can be better understood with reference to the following drawings. The components in the drawings are not necessarily to scale. Instead, emphasis is placed upon clearly illustrating the principles of the invention. Moreover, in the drawings, like reference numerals designate corresponding parts, or descriptively similar parts, throughout the several views and the disclosure.

FIG. 1 shows an example implementation of a collaborative platform in accordance with the disclosure.

FIG. 2 illustrates an example authorization operation that may be performed via the collaborative platform in accordance the disclosure.

FIG. 3 illustrates an example aggregation operation that may be performed via the collaborative platform in accordance the disclosure.

FIG. 4 illustrates an example server-related operation that may be performed via the collaborative platform in accordance the disclosure.

FIG. 5 illustrates another example server-related operation that may be performed via the collaborative platform in accordance the disclosure.

FIG. 6 illustrates some example components that can be included in a personal communication device that can be a part of a collaborative platform in accordance the disclosure.

FIG. 7 illustrates an example sequence of operations that may be executed in accordance with the disclosure.

FIG. 8 illustrates a first example operation that can be executed in accordance with the disclosure.

FIG. 9 illustrates a second example operation that can be executed in accordance with the disclosure.

FIG. 10 illustrates a third example operation that can be executed in accordance with the disclosure.

FIG. 11 shows some example components included in a personal communication device that can be a part of the collaborative platform in accordance with the disclosure.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein. For example, it will be understood that various words, labels, and phrases are used herein for description purposes and should not be interpreted in a limiting manner.

In particular, the word “example” as used herein is intended to be non-exclusionary and non-limiting in nature. One of ordinary skill in the art will understand the principles described herein and recognize that these principles can be applied to a wide variety of scenarios, using a wide variety of tools, processes, and physical elements.

Words such as “implementation,” “scenario,” “case,” and “situation” must be interpreted in a broad context, and it must be understood that each such word represents an abbreviated version of the phrase “In an example “xxx” in accordance with the disclosure” (where “xxx” corresponds to “implementation,” “scenario,” “case,” “situation” etc.).

The word “information” as used herein may be embodied in various forms including, for example, in the form of digital data stored in a device and/or conveyed from one device to another. The digital data may be generated, for example, by encoding a voice signal, by digitizing text, and/or by digitizing an image.

The word “group” as used herein refers to any two or more individuals who share a common goal and common interests, such as, for example, to obtain short-term financial gain and/or long-term financial gain. Members of a “group” can include, for example, friends, family members, colleagues, strangers, and/or members of a church, a school, or any other institution. It must be understood that words such as “individual” and “user” may be used interchangeably in this disclosure and can refer to members of the group in some scenarios and various other persons in some other scenarios.

The label “personal communication device” as used herein refers to any of various types of devices that may be used for various purposes, including for purposes of communicating information (via voice, text, and/or images, for example). A non-exhaustive list of personal communication devices can include a smartphone, a tablet computer, a phablet (phone plus tablet), a laptop computer, a wearable device (a smartwatch, for example), and a desktop computer. In an example use-case scenario, information containing text and/or image content may be propagated from a smartphone (a personal communication device operated by a first individual) to a laptop computer or a desktop computer (another personal communication device operated by a second individual).

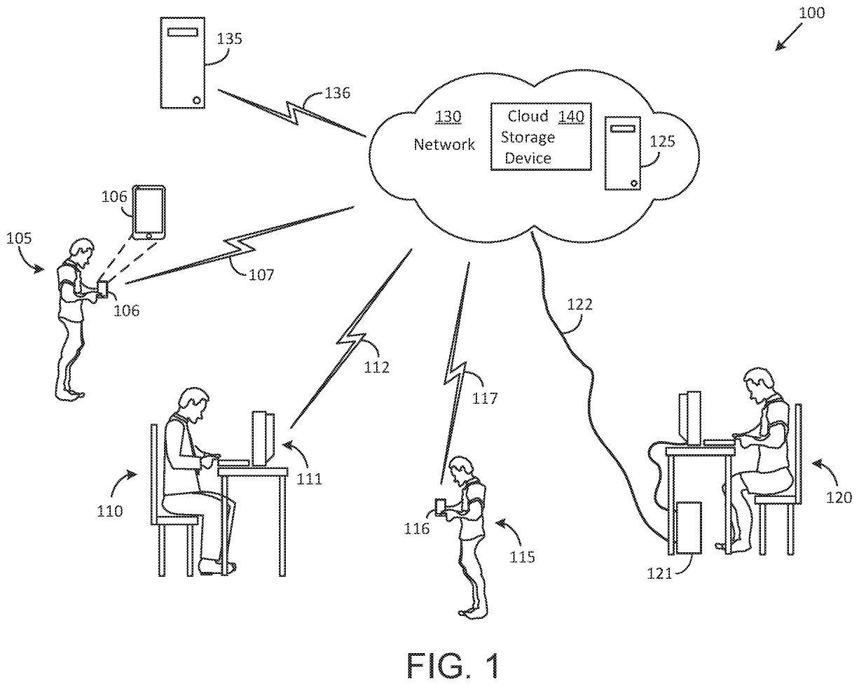

FIG. 1 shows an example implementation of a collaborative platform 100 in accordance with the disclosure. In terms of a general overview, the collaborative platform 100 may be utilized for various purposes such as, for example, to share various types of information on specific subjects of interest between one or more individuals or members of a group of people. More particularly, a software application provided in any of various types of personal communication devices, can identify in an email, an item that is a subject of interest to the group, and can parse the email to obtain information about the item. The information about the item may then be shared among members of the group.

In an example implementation, the subject of interest can be operations associated with financial products such as, for example, stocks, cryptocurrencies, non-fungible tokens (NFTs), mutual funds, savings funds, precious commodities, precious metals, etc. A subject of interest can also be associated with, for example, personal finance, finance planning, monitoring of finances, savings, savings planning, and various types of investment vehicles, to name a few. Operations associated with these various subjects of interest, may, in at least certain cases, replace, supplement, or complement, traditional approaches associated with, for example, financial planning, investing, saving, and access to capital.

Various technical advantages provided by the collaborative platform 100 may include evaluating a stream of emails and/or a large number of emails in a real time mode of operation so as to identify various items and actions that may be time critical. For example, the collaborative platform 100 may be used to evaluate a stream of emails not limited to a single personal communication device but to a number of personal communication devices belonging to members of a group of people. The collective information derived from such a configuration cannot be replicated by manual procedures where an individual reads through each received email to find an item of interest to share with others. Delays associated with manual procedures may be disadvantageous in situations that are time critical such as, for example, in stock trading. The collaborative platform 100 not only provides for identifying an item of interest in an email but can also set in motion a sequence of actions that offers several technical advantages. The sequence of events may be executed in the form of various state changes in various computing elements in the manner described below. The state changes can include, for example, evaluating an email to identify an item of interest, transferring information about the item of interest to a database, updating the database with new information pertaining to the item of interest based on information gathered by one or more members of the group, and providing data from the database to carry out automated actions without human intervention (such as, for example, defining a personal financial plan for a member, selling an undesirable asset of a member, and/or buying a desirable asset for a member).

Some example operations that may be carried out by use of the collaborative platform 100 can include importing of financial information from a financial institution (balances, transactions, loans, etc.); identifying, grouping, and categorizing various types of transactions (recurring transactions, one-time transactions, pending transactions, etc.); generating a customized budget; maintaining and updating the customized budget; sharing budgeting progress collaboratively with members of the group; collaborating on investment and budgeting strategies, tips, news and guide media with members of the group; managing a personal portfolio and/or an investment watchlist; offering a messaging feature for sharing various type of information with members of the group; sharing polling information, member-related information, and investment suggestions; supporting various plug-ins that may not be integral components of the collaborative platform 100; sharing investment portfolios with one or more members of the group; operating a group chatbot to answer investment and budgeting questions and suggest investment ideas and strategies; importing of investment transactions from a financial institution such as a brokerage firm; providing user profiles that may be viewed by members of the group; simulating investment options (based, for example, on a personal financial plan associated with a member of the group); automatic budgeting based on financial habits of a member (actions can include importing, identifying and labeling transactions obtained from various financial institutions such as banks and brokerage firms); investment education and advice may provide non-professional investors (as well as professional investors) access to various investment strategies, industry news, and knowledge; identifying potential investments based on investment exploration, portfolio simulation, crowd-sourced tips, artificial intelligence (A.I.) based investment recommendations, peer recommendations and/or professional recommendations; cooperatively advancing financial wellbeing of an individual as well as of members of a community; manual and automated investment operations; sharing information (such as investment insights) via group messaging and contextualization; aligning investment ideas by gathering the knowledge of a community via polls and messaging; group investing allows a community to share investment costs and invest in various financial vehicles such as stocks, exchange traded funds (ETFs), real estate investment trusts (REITs), commodities, and derivatives; investment mirroring, which allows an individual to tailor his/her portfolio based on mirroring investment strategies and operations performed by other individuals; personal investment funds that allow investing a portion of an individual's portfolio into a shared portfolio (the portion of the portfolio can include full or partial investments that mirror the investments in the shared portfolio); and/or automatic execution of investment procedures that can be executed with or without human intervention.

The collaborative platform 100 provides various technical advantages that may be associated with performing various operations such as the example ones indicated above. The collaborative platform 100 can, for example, provide a first technical advantage in terms of automating the process of examining emails for content that is of specific interest to a group of people rather than to a broad spectrum of the public. The customized and personalized nature of searching and identifying an item of interest that may be present in any of multiple emails, is in contrast to a generalized search that is aimed, for example, at detecting spam content in an email. Filtering of spam content typically involves constant updating of words, phrases, and types of content, that may be used by spam filters. In contrast, the email evaluation process in accordance with the disclosure may dispense with having to constantly update a search procedure for detecting an item of interest inside incoming emails.

As another example of a technical advantage, the collaborative platform 100 allows for sharing of information, particularly confidential information, amongst a group of people in a more secure, convenient, and closed environment in comparison to, for example, sharing information via a social media platform that is accessible to various people. The social media platform may allow for misuse of the information by people such as, for example, a friend-of-a-friend who is a stranger to the person providing the information on the social media platform.

In the example configuration shown in FIG. 1, the collaborative platform 100 has a distributed architecture where various components of the collaborative platform 100 are provided in various example devices. The various example devices can include a smartphone 106, a smartphone 116, a laptop computer 111, a desktop computer 121, a cloud computer 125, a cloud storage device 140, and a server computer 135. The smartphone 106, the smartphone 116, the laptop computer 111, and the desktop computer 121 are a few examples of what is referred to herein as a personal communication device.

The various devices are communicatively coupled to each other via a network 130. The network 130, which can be any of various types of networks such as, for example, one or more of a wide area network (WAN), a local area network (LAN), a public network, and/or a private network, may include various types of communication links (a wired communication link, a wireless communication link, an optical communication link, etc.) and support one or more of various types of communication protocols (Transmission Control Protocol (TCP), Internet Protocol (IP), Ethernet, Post Office Protocol (POP), Simple Mail Transfer Protocol (SMT), File Transfer Protocol (FTP), Hyper Text Transfer Protocol (HTTP), and Hyper Text Transfer Protocol Secure (HTTPS), etc.)

In the illustrated example scenario, the smartphone 106 is coupled to the network 130 via a wireless communication link 107, the laptop computer 111 is coupled to the network 130 via a wireless communication link 112, the smartphone 116 is coupled to the network 130 via a wireless communication link 117, and the desktop computer 121 is coupled to the network 130 via a wired communication link 122. The server computer 135, which may be located in various places such as, for example, on the premises of an Internet service provider, is coupled to the network 130 via a wired communication link 136. In another example configuration, the server computer 135 is configured as a cloud computer that is accessible via the network 130 (the Internet, for example).

The cloud computer 125 may be accessed by various individuals such as, for example, the individual 105, the individual 110, the individual 115, and the individual 120, for various purposes. For example, the cloud computer 125 may be used for personal finance activities such as accessing and operating online versions of financial tools offered by various companies (Quicken®, for example) and institutions (bank, brokerage firm, etc.).

The cloud storage device 140 (and/or the cloud computer 125) may be used for storing various types of information such as, for example, a database containing financial data associated with an individual (budget data, planning data, portfolios, inventory, assets information, etc.).

The server computer 135 may be owned, operated, and maintained by various entities such as, for example, an email service provider, a financial institution (bank, brokerage firm, credit bureau, credit card issuer, private lending agency, etc.), a government agency (federal, state, county, etc.), and a public service agency (community services, public records, etc.).

In an example configuration, the server computer 135 operates as an email server of a service provider, and can be accessed by various individuals such as, for example, an individual 105 (via the smartphone 106), an individual 110 (via the laptop computer 111), an individual 115 (via the smartphone 116), and an individual 120 (via the desktop computer 121).

In another example configuration, the server computer 135 may host a utility that allows an individual to download a software application into a client device (a personal communication device, for example). The software application may be executed in the client device to perform various operations of the collaborative platform in accordance with the disclosure. The individual 105, the individual 110, the individual 115, and the individual 120 constitute a group of members that use the software application for purposes of collaborating with each other in areas of common interests. In an example scenario, the common interest may pertain to achieving financial goals in a cooperative manner by sharing information, advice, and recommendations with each other. As indicated above, the collaborative platform 100 can, for example, provide a technical advantage in terms of automating the process of examining emails for content that is of specific interest to a group of people rather than to a broad spectrum of the public. As another example of a technical advantage, the collaborative platform 100 allows for sharing of information, particularly confidential information, amongst a group of people in a more secure, convenient, and closed environment in comparison to, for example, sharing information via a social media platform.

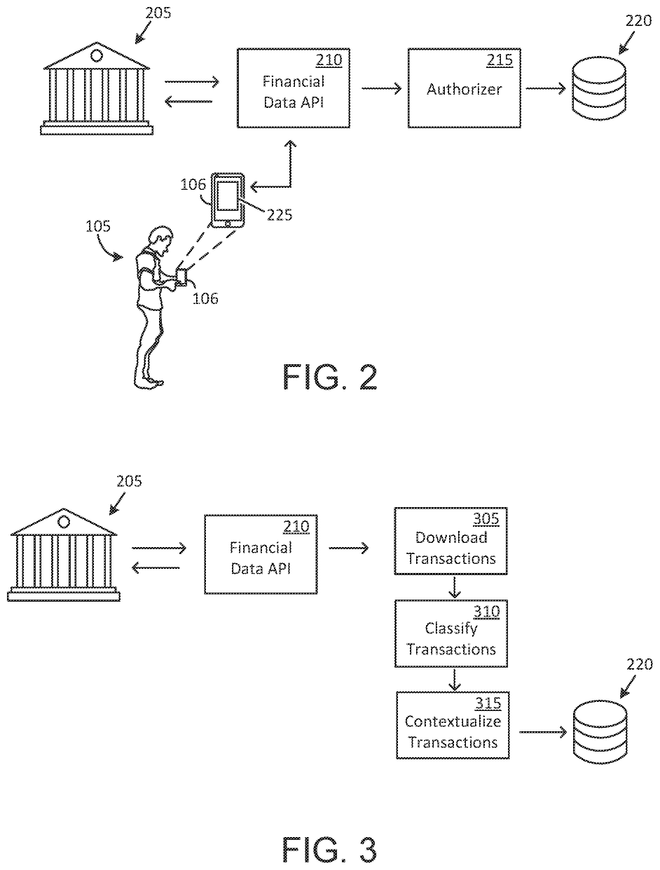

FIG. 2 illustrates an example authorization operation that may be performed via the collaborative platform 100 in accordance with the disclosure. The individual 105 may operate upon a graphical user interface (GUI) 225 of a software application that can be downloaded into the smartphone 106 from the server computer 135. In another implementation, the individual 105 may use a browser to access a website and perform various operations in accordance with the disclosure. The website may include a platform having features that provides functionalities such as those provided by the GUI 225.

In an example scenario, the software application interacts with a financial data application specific interface (API) 210 that may be provided by an entity having unknown credentials. The financial data API 210 communicates with a financial institution 205 for receiving financial data of the individual 105 (a bank balance, savings information, credit information, etc.).

An authorizer module 215 that can be a part of the server computer 135 and/or of the cloud computer 125, receives the financial data from the financial data API 210 and performs an authorization procedure (password verification, checksum verification, etc.) in cooperation with the GUI 225. Upon successful authorization, the financial data may be stored in a database 220. The database 220 may be located in the server computer 135, the cloud computer 125, and/or the cloud storage device 140, for example, and can be accessed by the individual 105 for various purposes. An example technical advantage provided by the authorization operation relates to integrating objects such as the API 210 provided by a third-party provider with a module such as the authorizer module 215 that can be configured, modified, and/or administered by personnel associated with the collaborative platform 100.

FIG. 3 illustrates an example aggregation operation that may be performed via the collaborative platform 100 in accordance with the disclosure. In this implementation, the financial data API 210 provides the data to a module 305 (after authorization by the authorizer module 215, in some cases). The module 305 downloads various transactions (for example, cash withdrawals, deposits, money transfers, etc.) associated with the financial institution 205. Another module 310 classifies the various transactions, and a module 315 contextualizes the classified transactions (for example, cash withdrawal for paying rent, salary deposit, money transfer for paying loan, etc.). The various modules may be provided in devices such as the server computer 135 and/or the cloud computer 125. Information pertaining to the contextualized transactions may be stored in a database, such as, for example, the database 220.

The aggregation operation can be carried out by incorporating various techniques for executing various functions. In one example implementation, the module 310 can execute an artificial intelligence procedure to evaluate and classify financial data received via the financial data API 210. In another example implementation, the module 310 can execute a machine learning procedure for evaluating and classifying financial data received via the financial data API 210. The use of such techniques allows for computer-executed operations that make various manual operations redundant, unnecessary, and inefficient. One such manual operation may involve an individual (such as the individual 105) examining a significant number of bank statements in order to identify subject matter that may be of interest to members of the group.

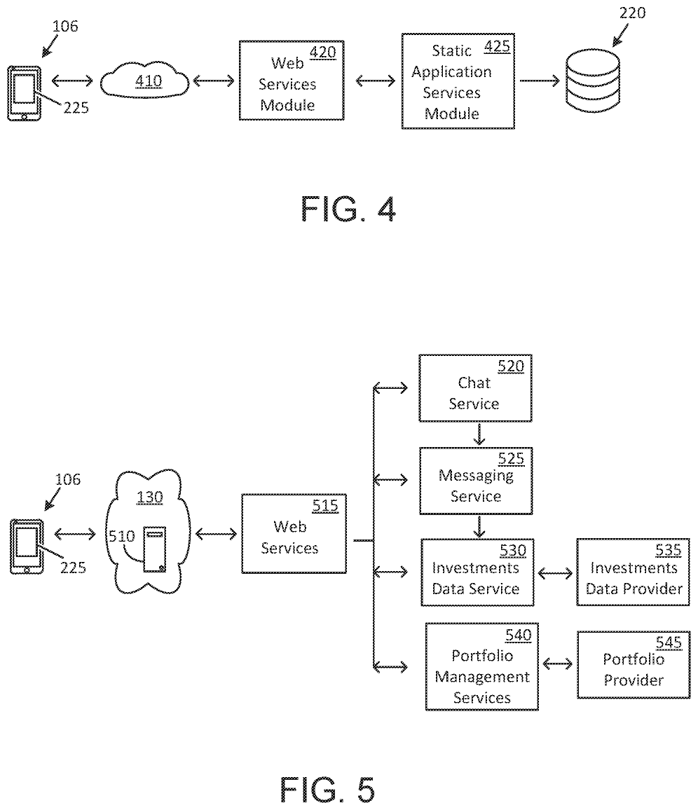

FIG. 4 illustrates an example server-related operation that may be performed via the collaborative platform 100 in accordance with the disclosure. The individual 105 may use the GUI 225 to initiate server-related operations such as a load balancing operation 410. The load balancing operation 410 may be performed prior to transferring data to a web services module 420 and a static application services module 425. The load balancing operation may be carried out by a service provider, for example, in order to route ensure efficient utilization of resources such as gateways, routers, and other such devices.

The web services module 420 and the static application services module 425 may be provided in devices such as, for example, the server computer 135 and/or the cloud computer 125. Data associated with the static application services, which can include, for example, financial services and information related to finances pertaining to the individual 105, may be stored in a database such as, for example, the database 220. The arrangement shown in FIG. 4 allows for efficient use of various devices and web services for purposes of providing information of interest to members of the group.

FIG. 5 illustrates another example server-related operation that may be performed via the collaborative platform 100 in accordance with the disclosure. In an example scenario, the software application in the smartphone 106 may be executed for providing server-related services. The individual 105 may, for example, use the GUI 225 to interact with one or more cloud-based platforms hosting cloud products such as offered, for example, by Google®, Amazon®, and Microsoft®. Device 510 represents an example cloud product.

A web services module 515 communicates with the device 510 (and/or other devices hosting cloud-based services) to exchange information related to various types of services.

Devices such as, for example, the server computer 135 and/or the cloud computer 125, may be configured to host various types of modules that can be a part of collaborative platform 100. Some example modules can include a chat service module 520, a messaging service module 525, an investments data service module 530, and a portfolio management services module 540. The investments data service module 530 may communicate with an investments data provider 535 (various financial institutions) and/or with devices, modules, and/or platforms associated with providing financial information such as, for example, real-time market data provided by a Yahoo® Finances platform. The portfolio management services module 540 may communicate with a portfolio provider 545 (a brokerage firm, for example) for purposes such as associated with portfolio information (stock holdings, equity in assets, precious commodities, trading information, etc.).

A technical advantage provided by the configuration shown in FIG. 5, and other figures referred to in this disclosure, pertains to an efficient integration of various devices and services in order to identify information that is of interest to members of the group and to act upon the information in an advantageous manner. In an example implementation that provides a technical advantage, the configuration shown in FIG. 5 can be configured to execute operations in real time based on cooperation between the various devices. For example, an item that is detected inside an email received in the personal communication device 106 can automatically trigger a sequence of events. The sequence of events includes automatically sharing of information about the item with other members of the group (such as via a GUI on each of the other personal communication devices, via a bulletin board that can be accessed by members of the group, and/or via a newsfeed displayed on the other personal communication devices). The sharing of information may be carried out for example, by transferring information from the personal communication device 106 to the device 510, the investments data service 530 module, and the investments data provider 535 (and/or from the personal communication device 106 to the device 510, the portfolio management services module 540 and the portfolio provider 545).

Furthermore, a technical advantage provided by the configuration shown in FIG. 5, and other figures referred to in this disclosure, includes a database associated with the investments data provider 535 (a brokerage firm, for example) that may be updated in real time based on the information received from the personal communication device 106 and other personal communication devices as well as user interactions with the data that could alter various data tags and states. In an example scenario, information about the item may be validated, corrected, or deleted based on information received from multiple personal communication devices. Information contained in the database can be provided to various members of the group for use in an individualized manner by each member. Based on the user interactions with the data that is parsed and shared with a user, certain tags or states associated with the data in the database can be changed or updated. For example, if a user replicates a trade based on the information received, the data in the database corresponding to the information can receive a first type of state that is opposite to a second type of state reserved for when the user decides not to replicate a trade based on the information received.

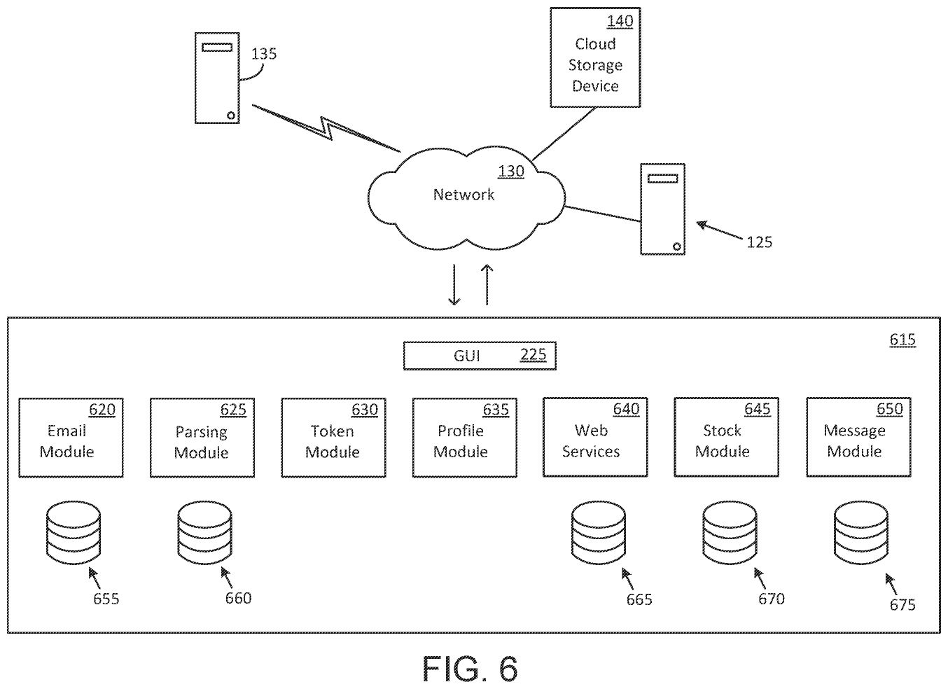

FIG. 6 illustrates some example components of a system 615 that may be provided in a personal communication device such as, for example, the smartphone 106. In an example operational procedure, the individual 105 downloads and launches a software application in the smartphone 106. The software application provides a GUI 225 that is displayed on a display screen of the smartphone 106 and can be used for various purposes such as, for example, to peruse displayed content (emails, notifications, images, etc.) and for performing various operations in accordance with the disclosure. In another example operational procedure, the individual 105 may use a browser to access a website and perform various operations in accordance with the disclosure. The website may include a platform having features that provides functionalities such as those provided by the GUI 225.

An example operation may involve identifying in an email, an item that is a subject of interest to a group of members and parsing the email to obtain information about the item that may be shared with one or more members of the group. The information may pertain to various subjects of interest such as stocks, cryptocurrencies, various types of investment vehicles, personal finance, finance planning, monitoring of finances, savings, and savings planning, to name a few.

In one example scenario, the group may be a private group and in another example scenario, the group can be a public group. Acceptance to a private and/or a public group may involve a sign-up procedure and acceptance to the group. In one case, acceptance to the group may be subject to verification and/or authentication by an existing member of the group or by a responsible party (close friend, colleague, etc.). In an example configuration, the existing member of the group may provide an indication that it is acceptable for an authenticated member to send information obtained by the authenticated member and/or obtained by a friend of the authenticated member. The friend of the authenticated member may or may not be a friend of the existing member receiving the information. In an example scenario, a circle of friends may be formed by a subset of members (and non-members) for obtaining and sharing information with members of the group. The circle of friend may have access to items such as, for example a contact list of each of the members of the circle of friends.

The example components of the system 615 include an email module 620 that enables access to an email gateway (such as, for example, the server computer 135 when configured to host an email service such as Yahoo® or Gmail by Google®). In an example configuration, the email module 620 is integrated into, or cooperatively coupled, to an email utility in the smartphone 106 that displays email messages, and can be used for sending and receiving emails. In one case, the email utility may display emails inside a web browser or in a window that may be a part of the GUI 225. In another implementation, emails may be displayed in a window that is located outside the GUI 225 and operated via an independent email program. In some cases, the server computer 135 may be also configured to operate as a push notification gateway that automatically provides notifications to the smartphone 106.

In an example operational scenario, the server computer 135 provides a notification to indicate that a new email has been received at the email gateway. In another example operational scenario, where the individual 105 uses a browser to access a website associated with the collaborative platform 100, a new mail notification may be provided in the form of a web URL callback, for example. The email module 620 may respond to the notification by sending out a request to the server computer 135 to forward the new mail to the smartphone 106. Upon receiving the new email, the email module 620 may call the parsing module 625 to parse the received email for purposes such as to identify, if present in the email, an item that is a subject of interest to the members of the group. In one scenario, the subject of interest (stock trading, for example) may be defined by the individual 105 via the GUI 225.

A processor (not shown) in the smartphone 106 may execute the parsing module 625. In an example parsing procedure executed via the parsing module 625, the processor evaluates metadata content of the email to determine whether the email includes material pertaining to the subject of interest. The metadata content may be present in various places, such as, for example, in a header portion of the email and/or in the email content portion of the email. The header portion may provide an indication about a subject matter of the email (for example, a description of a transaction that is of interest to members of the group), an email address of a sender of the email (a member of the group, for example), email addresses of other recipients of the email (other members of the group), and an IP address of a computer used to originate the email.

The parsed email, as well as other emails that contain items pertaining to the subject of interest, may be stored in an email database 655. The processor may proceed with executing additional operations of the parsing module 625, which can include evaluating the content of the email to identify and locate the item. Evaluating the email can involve techniques such as character recognition of text (and/or html symbols), image processing of images (screenshots of a transaction, for example), machine learning, natural language processing, and comparison procedures (for example, comparing a content of the email with information stored in anonymized databases in the cloud).

In an example scenario, the item may be described in one or more words or symbols corresponding to a financial transaction such as, for example, “stock,” “fund,” “cryptocurrency,” “equity,” “option,” and “$” (currency symbol). Actions associated with the item may be described in various ways such as, for example, “buy,” “sell,” “conversion,” “executed trade,” “submitted trade,” “cancelled trade,” and “Kyle bought $NFLX and $AAPL stock.” Additional information associated with the item can include, for example, a date of a transaction, a number of shares associated with a transaction, price per share, cost involved, and fees.

The parsing operations performed by the processor (via execution of the parsing module 625) can further include identifying (for example, based on the header portion and/or the body of the email) an agency or a financial institution (stockbroker, brokerage firm, bank, etc.) associated with the financial transaction. After completion of the parsing operations, the parsed information pertaining to the item may be saved in the email database 655 and may be used for purposes such as archiving and retrieval for sharing with members of the group. In some example implementations, the parsed information pertaining to the item may be saved in the cloud computer 125 and/or cloud storage device 140 and access provided to one or more members of the group (subject to authorization by the individual 105).

The sharing and/or transmittal of information with one or more users or members of a shared group may be initiated via execution of the email module 620 by the processor. The sharing procedure, which can involve execution of other modules shown in FIG. 6, is described below in more detail.

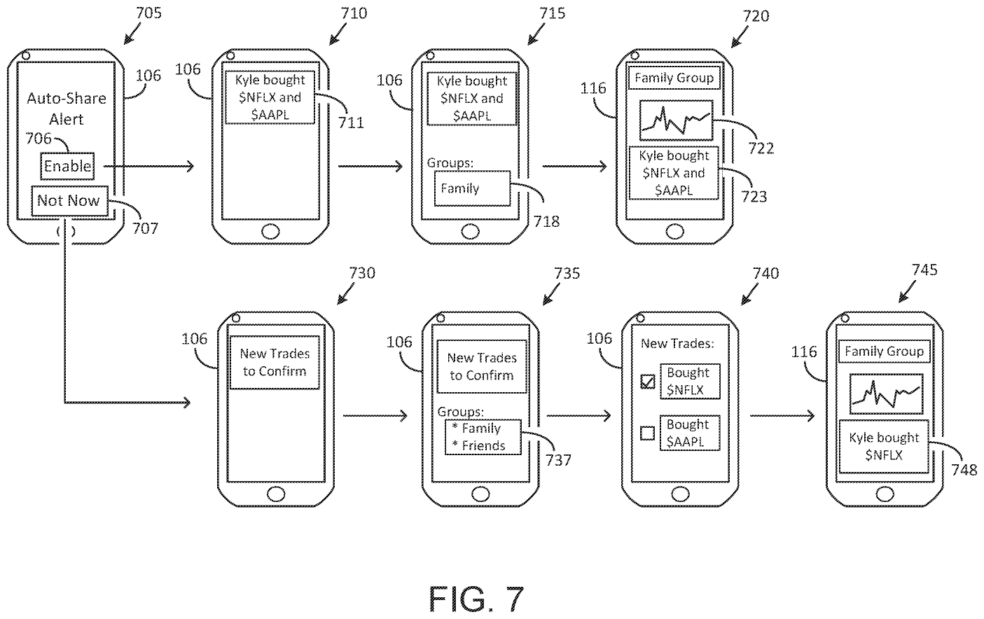

FIG. 7 illustrates an example sequence of operations that may be executed on one or more personal communication devices in accordance with an implementation of the disclosure. The description below is provided with reference to the smartphone 106 and the smartphone 116. It must be understood however, that the description is equally applicable to other personal communication devices. For example, in an alternative scenario, the operations described below with reference to the smartphone 106 and the smartphone 116 can be performed on the laptop computer 111 and the desktop computer 121 that are shown in FIG. 1.

A screenshot 705 of a display screen of the smartphone 106 shows some example text and icons. The text and/or icons may be displayed in various ways such as, for example, inside the GUI 225, in a browser outside the GUI 225, and/or in a window of a utility program (such as for example, an email utility program).

In the illustrated example, the screenshot 705 includes a message (“Auto-share Alert”) that is directed at drawing the attention of the individual 105 to an email containing an item of interest to the members of the group. The message may be displayed based on operations by the email module 620 and the parsing module 625 in the manner described above.

The screenshot 705 further includes an icon 706 to “Enable” auto-sharing of the item contained in the email that led to displaying of the “Auto-share Alert” message. The icon 706 is activatable by the individual 105 (by touching the icon 706 on a touchscreen of the smartphone 106, for example). Upon activation of the icon 706, the screenshot 705 transitions to a screenshot 710. The screenshot 710 shows a description 711 of the item contained in the email, which in the example illustration, reads: “Kyle bought $NFLX and $AAPL.” Various other messages can be displayed for other items that may not be related to financial matters, such as, for example, transactions (e.g., “Target has shampoo on sale”) or events (e.g., “Surprise birthday party at Tom's place at 7 PM today”).

The screenshot 710 may update to a screenshot 715 that includes an icon 718 to enable auto-sharing of the item contained in the email with members of a group labeled “Family.” The icon 718 is activatable by the individual 105 (by touching the icon 718 on a touchscreen of the smartphone 106, for example) to enable auto-sharing of the item contained in the email with members of a group labeled “Family.” The “Family” group may include some members of the family of the individual 105 who may be interested in a particular activity (stock trading, for example).

Upon activation of the icon 718, the information is transmitted from the smartphone 106 to the smartphone 116. The information may be transmitted by automatic execution of a message module 650 that is shown in FIG. 6. The message module 650 may access the email database 655 to fetch the parsed information pertaining to the item that is stored in the email database 655 (in the manner described above). The information may be propagated in any of various formats (email, text, html, etc.) through the network 130 to the smartphone 116.

The smartphone 116 receives the information and may display the information on a display screen of the smartphone 116 in various ways such as, for example, inside the GUI 225, in a browser outside the GUI 225, and/or in a window of a utility program (such as for example, an email utility program). In the illustrated example, a screenshot 720 of the GUI 225 includes a message block 723 that displays the transmitted information (“Kyle bought $NFLX and $AAPL”). The individual 115, who is a member of the “Family” group, may read and use the information as he/she desires.

In an example scenario, the individual 115 may obtain additional information about the item referred to in the message block 723. In this case, the additional information may be a graph 722 that shows a performance of the stock having the ticker symbol NFLX (or of the stock having the ticker symbol AAPL), over a period of time. Based on information obtained from the graph 722, and/or advice from the individual 105, the individual 115 may purchase shares of one or both companies.

Referring back to the screenshot 705, attention is drawn to an icon 707 that can be activated by the individual 105 to indicate to the collaborative platform 100 that the individual 105 does not desire to share the item contained in the email that led to displaying of the “Auto-share Alert” message. Upon activation of the icon 707, the screenshot 705 transitions to a screenshot 730. The screenshot 730 includes a message (“New Trades to Confirm”) that is directed at drawing the attention of the individual 105 to the pending action pertaining to the email containing the item of interest to members of the group.

Upon action taken by the individual 105 (touching the touchscreen of the smartphone 106, for example) the screenshot 730 may update to a screenshot 735 that includes an icon 737 that can be activated to enable sharing of the item contained in the email with members of the group labeled “Family” and/or members of another group labeled “Friends.” In an example implementation, the icon 737 may allow the individual 105 to make selections such as members of both the groups, one of the two groups, a member of a private group, and/or a member of a public group.

Upon activation of the icon 737, the screenshot 735 transitions to a screenshot 740 that allows the individual 105 to select either one, or both, the items contained in the email. In the illustrated example, the individual 105 opts to select the item labeled “Bought $NFLX” and omit selecting the item labeled “Bought $AAPL.”

Upon performing the selection, the information associated with the item labeled “Bought $NFLX” is transmitted from the smartphone 106 to the smartphone 116. The information may be transmitted by automatic execution of a message module 650 that is shown in FIG. 6. The message module 650 may access the email database 655 to fetch the parsed information pertaining to the item that is stored in the email database 655 (in the manner described above). The information may be propagated in any of various formats (email, text, html, etc.) through the network 130 to the smartphone 116.

The smartphone 116 receives the information and may display the information on a display screen of the smartphone 116 in various ways such as in the GUI 225, in a browser, and/or in a window of a utility program (such as for example, an email utility program). In this example, a screenshot 745 of the GUI 225 includes a message block 748 that displays the transmitted information (“Kyle bought $NFLX”). The individual 115 may read and use the information as he/she desires based on trust placed by the individual 115 upon the individual 105 who is providing the information.

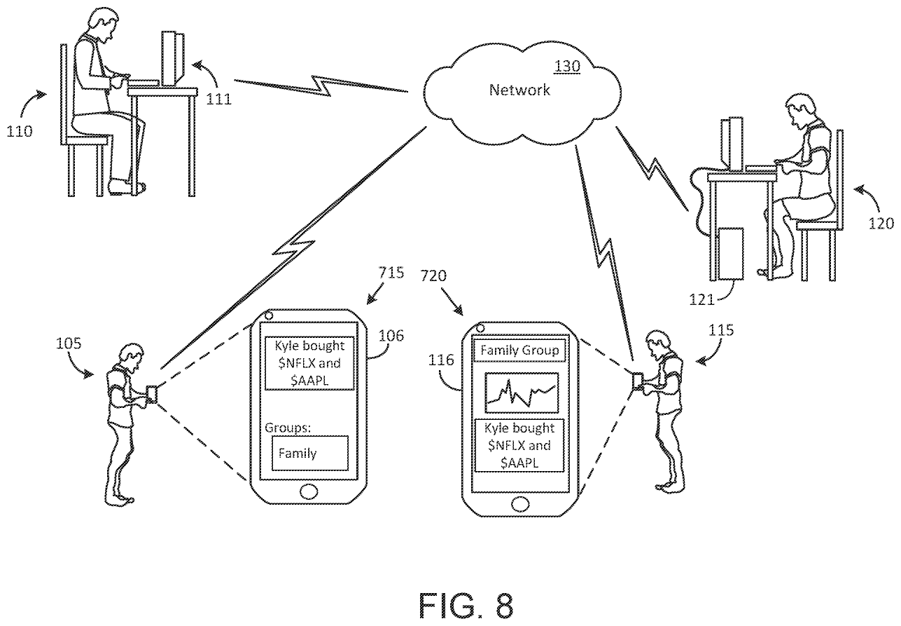

FIG. 8 illustrates a first example operation that can be executed upon the collaborative platform 100 in accordance with the disclosure. The first example operation pertains to sharing various types of information on specific subjects of interest between members of a group of people. In the illustrated scenario, an example item of interest (e.g., a trade alert related to a stock trade transaction executed by a member of the group) is shared with various members of the group. The screenshot 715 shown in the smartphone 106 of the individual 105, and the screenshot 720 shown in the smartphone 116 of the individual 115, have been described above. Display of the screenshot 720 may occur automatically when the stock trade transaction is performed. In an example implementation, the display is provided in real-time so as to enable a recipient of the information to take adavantage of the information such as, for purposes of making a stock trade transaction of his/her own.

The laptop computer 111 of the individual 110 and the desktop computer 121 of the individual 120 may display substantially identical screenshots. A software application provided in the smartphone 116 can be substantially identical to a software application provided in the smartphone 106, thereby allowing for bi-directional operations such as, when an item of interest (a stock trade transaction, for example) is identified in an email received in the smartphone 116. In this case, information pertaining to the item may be transmitted from the smartphone 116 to the smartphone 106 (and/or other devices).

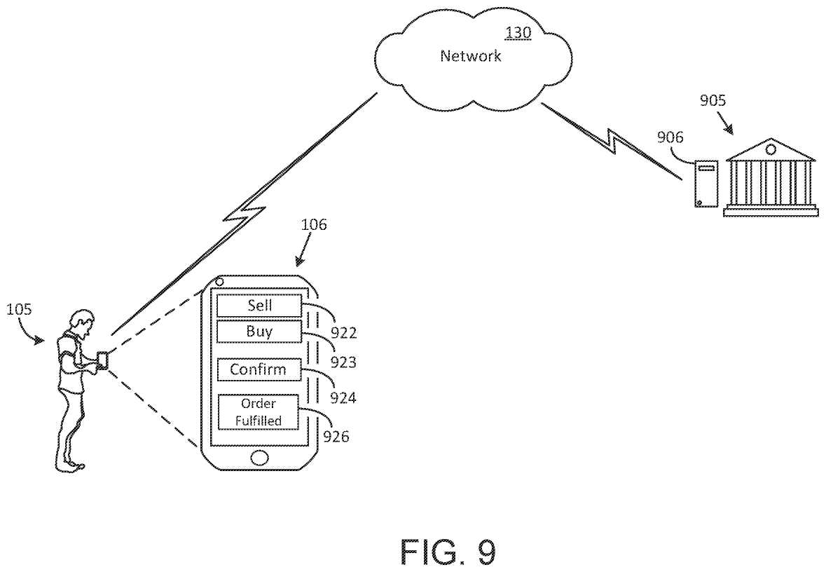

FIG. 9 illustrates a second example operation that can be executed upon the collaborative platform 100 in accordance with the disclosure. The second example operation pertains to performing a transaction in accordance with the disclosure. In this case, the operation is performed by the individual 105 by use of the smartphone 106. In other cases, the same transaction, and/or similar transactions, may be performed by other users including individuals using other personal communication devices.

The screenshot shown on the smartphone 106 includes various example icons such as, for example, an icon 922 that can be activated by the individual 105 for selling a financial holding (stock, bond, fund, precious metal, cryptocurrency, etc.), an icon 923 that can be activated by the individual 105 for buying a financial holding, an icon 924 that can be activated by the individual 105 for confirming that it is acceptable to proceed with executing a transaction (buying, selling, trading, closing a deal, etc.), and an icon 926 that can transition from a first display state to a second display state (a color change, for example) to indicate a fulfilment of a transaction.

In a first example implementation, the individual 105 may use the smartphone 106 to access his/her personal information from one or more sources such as a computer 906 of a financial institution 905. The financial institution 905 can be, for example, a bank (a computer 906 provides information about an account), a brokerage firm (the computer 906 provides information about stocks held), a credit bureau (the computer 906 provides information about a credit score), a credit card institution (the computer 906 provides information about available credit), and/or a lending institution (the computer 906 facilitates a loan application).

The information contained in the computer 906 can be alternatively provided in other devices such as, for example, in a personal computer of the individual 105. The personal computer may, for example, include a financial planning program (Quicken®, for example) and/or a database (a spreadsheet such as Excel® or Access®, for example). Information obtained from the financial planning program and/or the database can include, for example, information related to spending, savings, and assets of the individual 105. The assets can include, for example, a property that is owned by the individual 105, and may be leveraged based on equity for carrying out a transaction in accordance with the disclosure.

The information may be obtained via execution of one or more components of the system 615 that is shown in FIG. 6, such as, for example, a profile module 635, a token module 630, a web services module 640, a stock module 645, a token database 660, a profile database 665, a stock database 670, and/or a message database 675.

The obtained information may be used in various ways. In a first example scenario, the individual 105 may use the collaborative platform 100 to confer with members of the group on financial matters such as, for example, for drawing up a financial plan (a retirement plan, for example), for investing, for savings (recurring deposits into a savings account, tax withholding, etc.) and for taxes (strategies, tax deductions, etc.).

The individual 105 may also use the information to execute a transaction such as, for example, to define a personal financial plan, to buy stock, to sell an asset, and/or to deposit money into an account. The transaction may be executed via the GUI of the software application in accordance with the disclosure.

In a second example scenario, the individual 105 may use the collaborative platform 100 to confer with one or more other members of the group to obtain advice associated with performing an action upon an asset owned by the individual 105. As a part of this process, a determination may be made whether the asset is a desirable asset or an undesirable asset (a stock of a company, a property owned by the individual 105, for example).

Based on the determination, the individual 105 may execute an action such as, for example, buying a desirable asset (the stock of the company and/or the property) or selling an undesirable asset (the stock in the company and/or the property). The action may be carried out by using the software application to obtain input/advice from members of the group and use the input/advice to identify a trusted individual (a stockbroker, for example) and/or an institution (a brokerage firm, for example). The trusted individual and/or institution may be used to execute the transaction (a stock trade, for example).

The example scenarios described above pertain to the individual 105 performing various actions, such as accessing information from the computer 906 of the financial institution 905, drawing up a financial plan, and selling/buying an asset. In another implementation in accordance with the disclosure, some or all of these operations may be automatically carried out by the smartphone 106 without human intervention.

For example, a processor in the smartphone 106 may operate the software application to access the computer 906 of the financial institution 905 and obtain personal information of the individual 105. The processor may then automatically (without involvement of the individual 105) process and use the personal information (cash balance, assets owned, financial plan, etc.) to perform actions such as, for example, defining a financial plan, altering a personal plan (providing a recommendation to increase monthly tax withholding, modifying investment vehicles, etc.), placing a sell order on an undesirable asset, and/or placing a buy order on a desirable asset. Various icons such as the icon 922, icon 923, and icon 924 may be disabled or removed from the screenshot on the GUI during these operations. The icon 926 may be displayed in order to inform the individual 105 that the smartphone has automatically executed an operation.

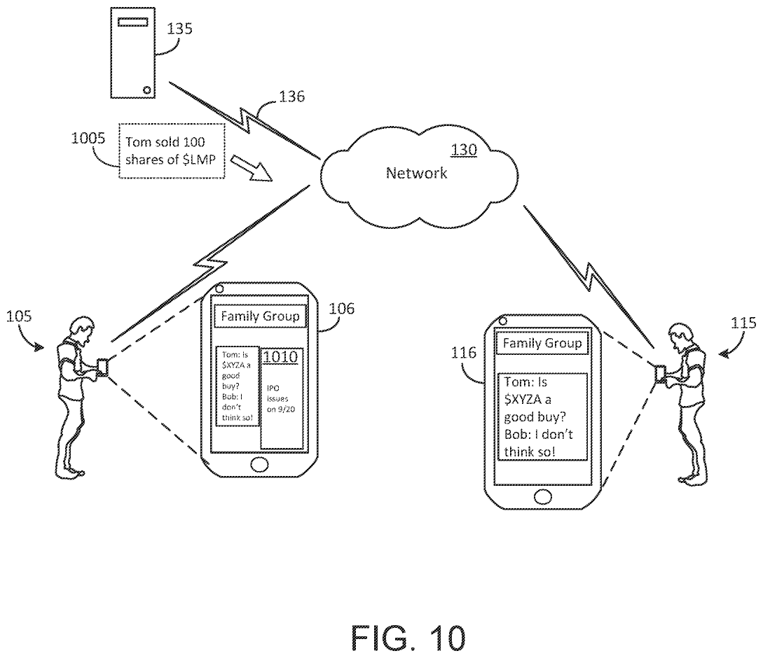

FIG. 10 illustrates a third example operation that can be executed upon the collaborative platform 100 in accordance with the disclosure. The third example operation pertains to using the collaborative platform 100 to communicate with one or more members of the group. In the illustrated scenario, the individual 105 uses the software application in the smartphone 106 to communicate with the individual 115 via the software application in the smartphone 116. In other scenarios, the individual 105 may communicate with more than one member concurrently.

In a first implementation, the communications may be carried out via a chat utility provided by the software application. In the illustrated scenario, the individual 115 (Tom) transmits a query about a stock (stock ticker $XYZA) to the individual 105 (Bob), who responds to the query. The query and the response may be displayed inside a chat box on the smartphone 106 and a chat box on the smartphone 116. The chat box may display queries and responses from multiple members when the individual 105 is carrying out a group chat.

In a second implementation, the communications may be carried out through a third-part utility (such as an email utility provided by Yahoo® or Gmail by Google® or an instant messaging (IM) utility) that is operatively coupled to the software application of the collaborative platform 100.

In a third implementation, a member of the group, such as, for example, the individual 105, may post information upon a bulletin board 1005 about an item of interest to the group. For example, the item of interest can be an action performed by a member such as for example, a stock trade executed by the individual 105. Other members of the group can see the bulletin board 1005 and perform actions of their own. As another example, the item of interest may be news about an upcoming initial public offering (IPO) of a stock of a company. Any member of the group can provide a comment, a response, a recommendation, or the like, upon seeing the posted information. In one scenario, the bulleting board 1005 may be hosted by the server computer 135.

In a fourth implementation, the collaborative platform 100 may be configured to support a newsfeed 1010 that is shown on an example device—the smartphone 106. The newsfeed 1010 may pertain to one or more items of interest to members of the group such as, for example, a heads-up of an upcoming IPO, followed by updates on the event or a trade that was executed by a member of the group, followed by real-time stock price fluctuations after the trade. In one scenario, any member may opt to either receive, or not receive the newsfeed.

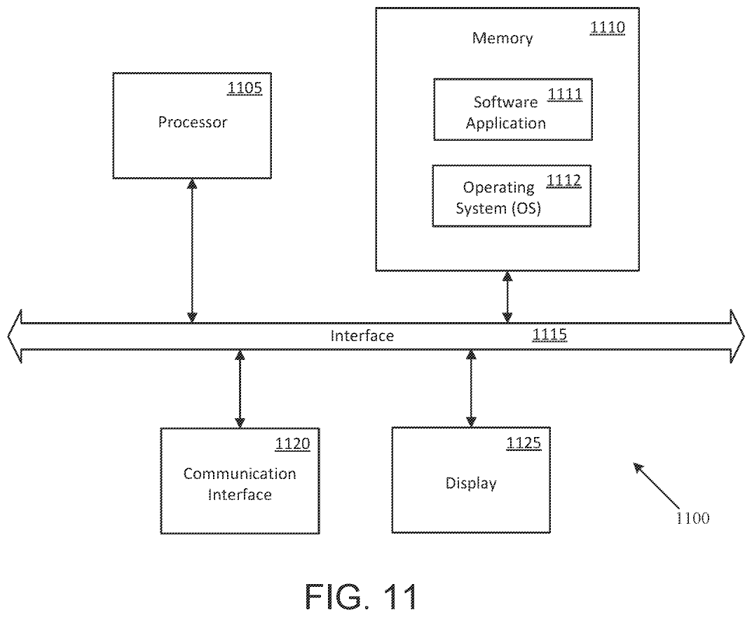

FIG. 11 shows some example components that may be provided in a personal communication device 1100 that can be a part of the collaborative platform 100 in accordance with the disclosure. The collaborative platform 100 may be implemented in hardware, software, firmware, or a combination thereof. In one implementation, a portion of the collaborative platform 100 is implemented in software, particularly in the form of an executable program executable by a processor of the personal communication device 1100.

Generally, in terms of hardware architecture, the personal communication device 1100 (smartphone 106, laptop computer 111, desktop computer 121, etc.) includes a processor 1105, a memory device 1110, a communications interface 1120, and a display 1125 that are communicatively coupled to each other via an interface 1115. The interface 1115 can be, for example but not limited to, one or more buses or other wired or wireless connections.

The interface 1115 may have additional elements, which are omitted for simplicity, such as controllers, buffers (caches), drivers, repeaters, and receivers, to enable communications. Furthermore, the interface 1115 may include address, control, and/or data connections to enable appropriate communications among the aforementioned components.

The processor 1105 is a hardware device for executing software, particularly computer-executable instructions stored in a computer-readable storage medium such as, for example, the memory device 1110. The processor 1105 can be any custom made or commercially available processor, a central processing unit (CPU), an auxiliary processor among several processors associated with the personal communication device 1100, a semiconductor-based microprocessor (in the form of a microchip or chip set), a macroprocessor, or generally any device for executing software instructions.

The memory device 1110, which is one example of a non-transitory computer-readable storage medium, may be used to store an operating system (OS) 1112 and code modules such as the software application 1111. The code modules are provided in the form of computer-executable instructions that can be executed by the processor 1105 for performing various operations in accordance with the disclosure. In an example implementation, the software application 1111 may be downloaded into the personal communication device 1100 from a server computer or from cloud storage.

The memory device 1110 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory device 1110 may incorporate electronic, magnetic, optical, and/or other types of storage media. Note that the memory device 1110 can have a distributed architecture, where various components are situated remote from one another, but can be accessed by the processor 1105.

The operating system 1112 essentially controls the execution of various software programs in the personal communication device 1100, including the software application 1111, and provides scheduling, input-output control, file and data management, memory management, and communication control and related services.

The software application 1111 may be a source program, an executable program (object code), a script, or any other entity comprising a set of instructions to be performed. When a source program, the program may be translated via a compiler, assembler, interpreter, or the like, which may or may not be included within the memory device 1110, so as to operate properly in connection with the O/S 1112. Furthermore, the software application 1111 may be written as (a) an object-oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The communications interface 1120 may include transmitting and receiving devices for transmitting information from the smartphone 106 to other devices and for receiving information from one or more other devices.

In some cases, where the personal communication device 1100 is a laptop computer, desktop computer, workstation, or the like, the software in the memory device 1110 may further include a basic input output system (BIOS) (omitted for simplicity). The BIOS is a set of essential software routines that initialize and test hardware at startup, start the O/S 1112, and support the transfer of data among various hardware components. The BIOS is stored in ROM so that the BIOS can be executed when the personal communication device 1100 is powered up.

When the personal communication device 1100 is in operation, the processor 1105 is configured to execute software stored within the memory device 1110, to communicate data to and from the memory device 1110, and to generally control operations of the personal communication device 1100 pursuant to the software. The software application 1111 and the O/S 1112, in whole or in part, but typically the latter, are read by the processor 1105, perhaps buffered within the processor 1105, and then executed. The display 1125 may be used for displaying a graphical user interface that is usable by an individual in the manner described above.

While the systems and methods have been described by means of specific embodiments and applications thereof, it is understood that numerous modifications and variations could be made thereto by those skilled in the art without departing from the spirit and scope of the disclosure.

Accordingly, it is to be understood that the inventive concept is not to be limited by the specific illustrated embodiments, but only by the scope of the appended claims. The description may provide examples of similar features as are recited in the claims, but it should not be assumed that such similar features are identical to those in the claims unless such identity is essential to comprehend the scope of the claim. In some instances, the intended distinction between claim features and description features is underscored by using slightly different terminology.

That which is claimed is:

1. A method comprising:
launching a software application in a first personal communication device that is a part of a collaborative platform;
executing, by a first processor in the first personal communication device, the software application;
evaluating, based on executing the software application, an email obtained from a server computer;
identifying, in the email, an item that is a subject of interest to members of a group that use the collaborative platform; and
transmitting, to a second personal communication device that includes the software application, information about the item described in the email.

2. The method of claim 1, wherein evaluating the email obtained from the server computer, comprises:
executing, by the first processor, a parsing procedure;
evaluating, as a part of the parsing procedure, a metadata content of the email; and
identifying, based on the metadata content of the email, that the email includes the item that is the subject of interest.

3. The method of claim 2, wherein the item comprises a description of a transaction that is of interest to members of the group, and wherein the method further comprises:
displaying the description of the transaction in a graphical user interface that is provided by the software application in the second personal communication device.

4. The method of claim 2, further comprising:
accessing, by one of the first processor in the first personal communication device or a second processor in the second personal communication device, a source that provides personal information of a member of the group;
defining, by the one of the first processor in the first personal communication device or the second processor in the second personal communication device, based on at least the personal information, a personal plan for the member of the group; and
executing, by the one of the first processor in the first personal communication device or the second processor in the second personal communication device, a transaction that is based on the personal plan.

5. The method of claim 4, wherein the source is at least one of a bank, a brokerage firm, a credit bureau, a credit card institution, a lending institution, a financial planning program, or a database of assets owned by the member of the group.

6. The method of claim 4, wherein the transaction is executed automatically by the one of the first processor in the first personal communication device or the second processor in the second personal communication device without human intervention.

7. The method of claim 2, further comprising:
evaluating, by one of the first processor in the first personal communication device or a second processor in the second personal communication device, a first asset owned by a member of the group;
determining, by the one of the first processor in the first personal communication device or the second processor in the second personal communication device, whether the first asset is one of a desirable asset or an undesirable asset; and
executing, by the one of the first processor in the first personal communication device or the second processor in the second personal communication device, an action upon the first asset based on the determination whether the first asset is one of a desirable asset or an undesirable asset.

8. A system comprising:
a server computer;
a first personal communication device comprising:
an email module configured to obtain an email from the server computer;
a first software application stored in a first memory device and executable by a first processor for performing at least a first operation of a collaborative platform, the first operation comprising evaluating the email obtained from the server computer and identifying, in the email, an item that is a subject of interest to members of a group that use the collaborative platform; and
a first communications interface configured to transmit information about the item that is described in the email to at least a second personal communication device.

9. The system of claim 8, wherein the first personal communication device is one of a smartphone, a tablet computer, a phablet (phone plus tablet), a laptop computer, a wearable device, or a desktop computer.

10. The system of claim 8, wherein the second personal communication device comprises a second software application that is substantially identical to the first software application, the second software application stored in a second memory device and executable by a second processor for performing at least a second operation of the collaborative platform, the second operation comprising displaying the item received from the first personal communication device.

11. The system of claim 10, wherein the first software application stored in the first memory device of the first personal communication device is further executable by the first processor for performing a third operation of the collaborative platform, the third operation comprising:
accessing a source that provides personal information of an individual;
defining, based on at least the personal information, a personal plan for the individual; and
executing, a transaction that is based on the personal plan.

12. The system of claim 11, wherein the source is at least one of a bank, a brokerage firm, a credit bureau, a credit card institution, a lending institution, a financial planning program, or a database of assets owned by the individual.

13. The system of claim 11, wherein the transaction is executed automatically by the first processor without human intervention.

14. The system of claim 10, wherein the first software application stored in the first memory device of the first personal communication device is further executable by the first processor for performing a third operation of the collaborative platform, the third operation comprising:
evaluating a first asset owned by an individual;
determining whether the first asset is one of a desirable asset or an undesirable asset; and
executing an action upon the first asset based on the determination whether the first asset is one of a desirable asset or an undesirable asset.

15. A computer-readable storage medium having computer-executable instructions for performing operations comprising:
executing, by a processor in a first personal communication device, a software application;
evaluating, by the processor, based on executing the software application, an email obtained from a server computer;
identifying, by the processor, in the email, an item that is a subject of interest to members of a group that use a collaborative platform which includes the first personal communication device and a second personal communication device; and
transmitting, by the processor, to the second personal communication device that includes the software application, information about the item described in the email.

16. The computer-readable storage medium of claim 15, wherein evaluating the email obtained from the server computer, comprises:
executing, by the processor, a parsing procedure;
evaluating, as a part of the parsing procedure, a metadata content of the email; and
identifying, based on the metadata content of the email, that the email includes the item that is the subject of interest.

17. The computer-readable storage medium of claim 16, wherein the operations further comprise:
accessing, by the processor, a source that provides personal information of an individual;
defining, by the processor, based on at least the personal information, a personal plan for the individual; and
executing, by the processor, a transaction that is based on the personal plan.

18. The computer-readable storage medium of claim 17, wherein the source is at least one of a bank, a brokerage firm, a credit bureau, a credit card institution, a lending institution, a financial planning program, or a database of assets owned by the individual.

19. The computer-readable storage medium of claim 17, wherein the transaction is executed automatically by the processor without human intervention.

20. The computer-readable storage medium of claim 16, wherein the operations further comprise:
evaluating, by the processor, a first asset owned by an individual;
determining, by the processor, whether the first asset is one of a desirable asset or an undesirable asset; and
executing, by the processor, an action upon the first asset based on the determination whether the first asset is one of a desirable asset or an undesirable asset.
